(19) United States
(12) Patent Application Publication
(10) Pub. No.: US 2009/0151146 A1
(43) Pub. Date: Jun. 18, 2009

(54) METHOD, DEVICE AND STRUCTURE FOR JOINING TWO MEMBERS TOGETHER

(76) Inventors: Kousuke Nagai, Kanagawa (JP); Osamu Ando, Kanagawa (JP); Kouhei Jiuchi, Kanagawa (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/192,439

(22) Filed: Aug. 15, 2008

(30) Foreign Application Priority Data
Dec. 18, 2007 (JP) 2007-325699

(51) Int. Cl. B23P 11/00; B21D 39/03

(52) U.S. Cl. 29/522.1; 29/283.5

(57) ABSTRACT

A method for joining a holed member, including a through-hole, and an unholed member together, the method includes deforming the unholed member against the through-hole of the holed member so that a flat portion of the holed member around the through-hole is deformed into the shape of a truncated conical projection and so that the unholed member is deformed along the truncated conical projection to partly project from the through-hole, and deforming a portion of the unholed member which projects from the through-hole to come into intimate contact with a wall surface of the through-hole of the holed member.

### BACKGROUND OF THE INVENTION

1. Field of the Invention

The present invention relates to a method, a device and a structure for joining two members together.

2. Description of the Prior Art

A method and an apparatus for joining two members together with no welding is known in the art and disclosed in Japanese unexamined patent publication H07-132422. This method and this apparatus are based on attention being directed to forming a through-hole in one of the two members in advance and forming a half shear portion on the other member which is brought into intimate contact with the inner surface of the through-hole, wherein the half shear portion is formed by squeezing a part of the other member into the through-hole with a first punch (punch for forming the half shear portion) and wherein the half shear portion is brought into intimate contact with the inner surface of the through-hole by swaging the half shear portion in lateral directions with a second punch (punch for swaging).

However, in the joining structure disclosed in JUPP H07-132422, since the half shear portion is simply in intimate contact with the inner surface of the through-hole and also since the peel strength is determined by the frictional resistance between the half shear portion and the inner surface of the through-hole, a sufficient strength cannot be obtained especially when the thickness of the member in which the through-hole is formed is small.

### SUMMARY OF THE INVENTION

In view of the above described problem, the present invention provides a method, a device and a structure for joining two members together, wherein a sufficient peel strength can be obtained while a structure, in which a through-hole is formed in one of the two members in advance, is maintained.

The present invention has been devised from the viewpoint that, in the case of deforming a member with no through-hole (i.e., unholed member) against a portion around a through-hole formed in another member (i.e., holed member), a sufficient peel strength is obtained by deforming a flat portion of the holed member around the through-hole into the shape of a truncated conical projection and further deforming the unholed member along the truncated conical projection to partly project from the through-hole.

According to an aspect of the present invention, a method is provided for joining a holed member, including a through-hole, and an unholed member together, the method including deforming the unholed member against the through-hole of the holed member so that a flat portion of the holed member around the through-hole is deformed into a shape of a truncated conical projection and so that the unholed member is deformed along the truncated conical projection to partly project from the through-hole; and deforming a portion of the unholed member which projects from the through-hole to come into intimate contact with a wall surface of the through-hole of the holed member.

Upon the truncated conical projection being formed, it is desirable for the wall surface to incline relative to a direction orthogonal to a plane in which the holed member lies.

Upon the portion of the unholed member coming into intimate contact with the wall surface, it is desirable for the portion of the unholed member which projects from the through-hole to be raised to form an annular raised portion positioned about a central axis of the through-hole.

It is desirable for the joining method to include holding the unholed member and the holed member between a swaging base and a die before deforming the unholed member against the through-hole.

In an embodiment, a joining device is provided for joining a holed member, including a through-hole, and an unholed member together, the joining device including a first swaging punch for deforming the unholed member together with a portion of the holed member around the through-hole; a second swaging punch for further deforming a portion of the unholed member already deformed by the first swaging punch within the through-hole; and a third swaging punch for holding the portion of the unholed member between the third swaging punch and the second swaging punch and deforming the portion of the unholed member so that the portion of the unholed member comes into intimate contact with a wall surface of the through-hole of the holed member.

It is desirable for the first swaging punch to include a swaging base and a die for holding the unholed member and the holed member therebetween.

It is desirable for the die to be shaped as a hollow cylinder, and for the third swaging punch to be concentrically positioned inside the hollow cylinder.

In an embodiment, a joining device is provided for joining a holed member, including a through-hole, and an unholed member together, the joining device including a swaging base and a die for holding the holed member and the unholed member therebetween; an annular contacting portion formed on the die and coming in contact with a first flat portion of the holed member around the through-hole; an annular tapered portion formed on the die and positioned inside the annular contacting portion so as to be concentric therewith; a first base swaging punch which is greater in diameter than the through-hole and is moved to project toward the annular tapered portion from the swaging base which is in contact with the unholed member to deform the unholed member so that a second flat portion of the holed member around the through-hole is deformed into the shape of a truncated conical projection and so that the unholed member is deformed along the truncated conical projection to partly project from the through-hole, the second flat portion being provided at a radially inner position with respect to the first flat portion; a second base swaging punch which is smaller in diameter than the first base swaging punch and projects toward a center of the truncated conical projection from the swaging base; and a die swaging punch for holding a portion of the unholed member which projects from the through-hole between the die swaging punch and the second base swaging punch, and for deforming the portion of the unholed member so as to come into intimate contact with a wall surface of the through-hole of the holed member.

Although the first base swaging punch and the second base swaging punch can be provided separately, it is possible that the first base swaging punch and the second base swaging punch be arranged to be concentric with each other and movable relative to each other.

The die swaging punch can plastically deform the unholed member sufficiently along the edge of the through-hole by forming the swaging end of the die swaging punch, which faces the second base swaging punch, into a conical projection.

It is desirable for the swaging base and the die to be relatively movable toward and away from each other along a central axis of the through-hole.

In an embodiment, a joining structure is provided in which a holed member, including a through-hole, and an unholed member are joined together, wherein the holed member is partly swaged into a truncated conical projection at the through-hole, the unholed member is partly swaged along the truncated conical projection to project from the through-hole, and a portion of the unholed member which projects from the through-hole, around which the truncated conical projection is positioned, is in intimate contact with a wall surface of the through-hole of the holed member.

It is desirable for the portion of the unholed member that projects from the through-hole to include an annular raised portion positioned about a central axis of the through-hole.

According to the present invention, the two members (the holed member and the unholed member) can be joined together with a sufficient peel strength because the flat portion of the holed member around the through-hole is deformed into the shape of a truncated conical projection while the unholed member is deformed along the truncated conical projection to partly project from the through-hole in the case of deforming the unholed member (member with no through-hole) against a portion around a through-hole formed in the holed member (member with a through-hole).

The present disclosure relates to subject matter contained in Japanese Patent Application No. 2007-325699 (filed on Dec. 18, 2007) which is expressly incorporated herein by reference in its entirety.

### BRIEF DESCRIPTION OF THE DRAWINGS

The present invention will be discussed below in detail with reference to the accompanying drawings, in which:

FIG. 1 is a vertical cross sectional view of an embodiment of a device for joining two members together; and

FIG. 2 is a vertical cross sectional view showing two stages of joining the two members together by the joining device shown in FIG. 1.

### DESCRIPTION OF THE PREFERRED EMBODIMENT

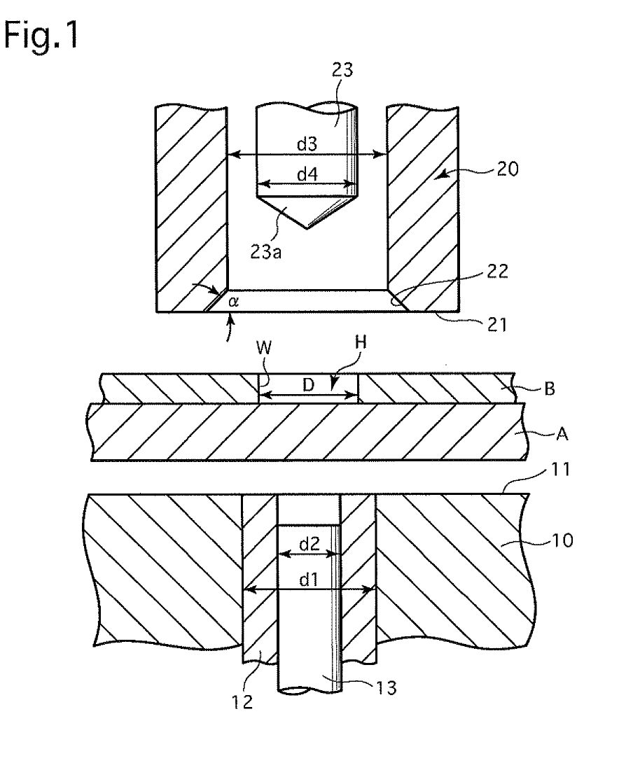

FIG. 1 shows an embodiment of a joining device that operates to implement a method of joining two members together. The joining device is used to join a non-through-holed member (unholed member/plate/board) A that does not include a through-hole and a through-holed member (holed member/plate/board) B that includes a through-hole H having an inner diameter D. The joining device is provided with a swaging base 10 and a die 20 which are movable relative to each other in directions toward and away from each other. All the elements of the joining device are rotationally symmetrical with respect to an axis (central axis of the through-hole H).

The swaging base 10 is provided with a flat mounting surface 11 on which the non-through-holed member A is mounted. The swaging base 10 is further provided with a first base swaging punch 12 and a second base swaging punch 13 each of which advances and retreats (moves upward and downward with respect to FIG. 1) from the flat mounting surface 11 in a direction orthogonal to the flat mounting surface 11. The first base swaging punch 12 and the second base swaging punch 13 are concentrically arranged to be movable relative to each other in the axial direction; specifically, the first base swaging punch 12 is formed as a hollow-cylindrical member and the second base swaging punch 13 is formed as a solid shaft which is slidably fitted into the first base swaging punch 12. The outer diameter d1 of the first base swaging punch 12 is greater than the inner diameter D of the through-hole H (i.e., d1>D) of the through-holed member B, and the outer diameter d2 of the second base swaging punch 13 is smaller than the inner diameter D of the through-hole H (i.e., d2<D).

The die 20 is in the shape of a hollow cylinder which is arranged concentrically with (but not physically around) the through-hole H of the through-holed member B. The die 20 is provided with an annular contacting portion 21 and an annular tapered portion 22. The annular contacting portion 21 comes in surface contact with a flat portion of the through-holed member B around the through-hole H to be concentric therewith, and the annular tapered portion 22 is formed immediately inside (radially inside) of the annular contacting portion 21 to be concentric therewith. The inner diameter d3 of the die 20 (the annular tapered portion 22) is greater then the inner diameter D of the through-hole H (i.e., d3>D). The generating line of the annular tapered portion 22 of the die 20 is angled relative to the annular contacting portion 21 at an angle α.

The joining device is provided in the center of the die 20 with a die swaging punch 23. The die swaging punch 23 can be made to be either integral with the die 20 or movable relative to the die 20 in the axial direction. One end of the die swaging punch 23 which faces the through-holed member B is formed into a conical tip 23a. The diameter d4 of the die swaging punch 23 is greater than the inner diameter D of the through-hole H (i.e., d4>D).

The manner of joining the non-through-holed member A and the through-holed member B will be hereinafter discussed. The non-through-holed member A is mounted on the flat mounting surface 11 of the swaging base 10, and subsequently, the through-holed member B is mounted on the non-through-holed member A with the through-hole H at a concentric position with respect to the first base swaging punch 12, the second base swaging punch 13 and the die 20. In this state, the swaging base 10 and the die 20 are brought close to each other so that the non-through-holed member A and the through-holed member B are held between the swaging base 10 and the die 20.

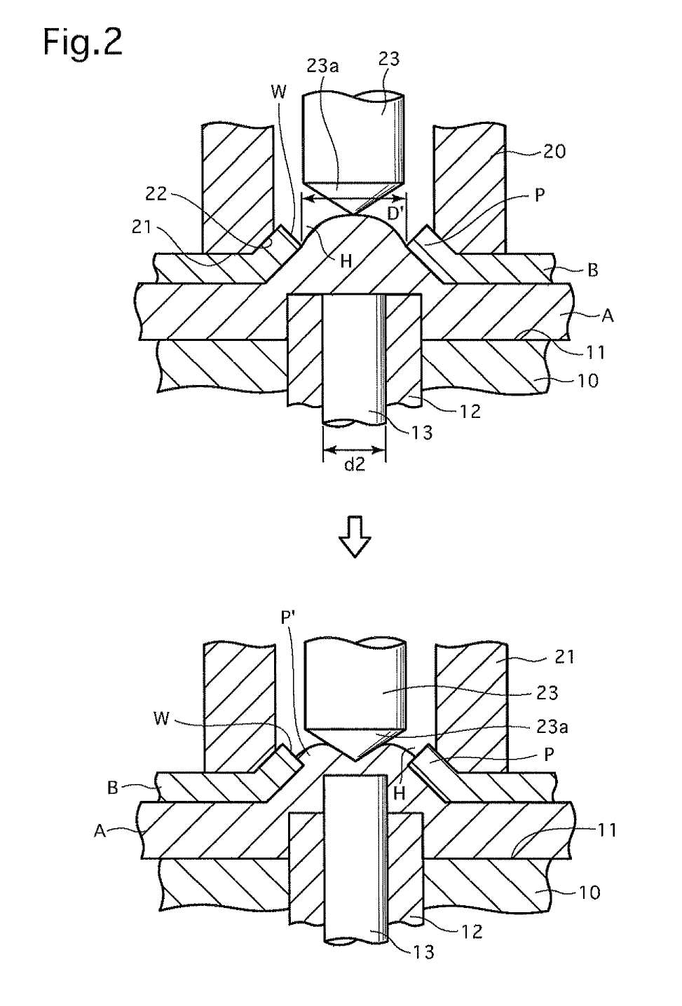

In this state where the non-through-holed member A and the through-holed member B are held between the swaging base 10 and the die 20, the first base swaging punch 12 and the second base swaging punch 13 with the respective swaging end surfaces (upper end surfaces with respect to FIG. 1) thereof being flush with each other are moved toward the die 20 to project from the flat mounting surface 11. This movement of the combination of the first base swaging punch 12 and the second base swaging punch 13 toward the die 20 causes a portion of the non-through-holed member A adjacent to the aforementioned swaging end surfaces to be pressed and plastically deformed toward the through-hole H of the through-holed member B by the swaging end surfaces of the first base swaging punch 12 and the second base swaging punch 13, thereby causing a flat portion of the through-holed member B around the through-hole H to be plastically deformed into a truncated conical projection P having a truncated hollow conical shape along the annular tapered portion 22 of the die 20. Simultaneously, the aforementioned portion of the non-through-holed member A adjacent to the operating surfaces of the first base swaging punch 12 and the second base swaging punch 13 is plastically deformed along the truncated conical projection P to partly project outward from the through-hole H (see the upper drawing in FIG. 2). The operations of the joining device having been described so far correspond to a step (first deforming step) for forming the truncated conical projection P on the through-holed member B. The first base swaging punch 12 (and the second base swaging punch 13) and the die 20 constitute a first swaging punch for deforming the non-through-holed member A together with a portion of the through-holed member B around the through-hole H.

With this first deforming step, an annular wall surface W of the through-holed member B in the through-hole H (hereinafter referred to as the wall surface W of the through-hole H) inclines relative to a direction orthogonal to a plane in which the through-holed member B (or the non-through-holed member A) lies. Under ideal working conditions, the angle of this inclination becomes identical to the angle α of the annular tapered portion 22 of the die 20. Additionally, the minimum inner diameter D′ (see the upper drawing in FIG. 2) of the through-hole H upon the completion of the above described first deforming step is greater than the diameter d2 of the second base swaging punch 13.

Subsequently, with the state in which the non-through-holed member A and the through-holed member B is held between the swaging base 10 and the die 20 maintained, the conical tip 23a of the die swaging punch 23 is brought into contact with the portion of the non-through-holed member A which projects from the through-hole H, while the second base swaging punch 13 is moved relative to the first base swaging punch 12 toward the die swaging punch 23 (upward as viewed in FIG. 2)(second deforming step). Thereupon, the portion of the non-through-holed member A which projects from the through-hole H is plastically deformed (swaged) radially outwards with respect to the axis of the second base swaging punch 13 (the axis of the die swaging punch 23) to come into intimate contact with the wall surface W of the through-hole H (see the lower drawing in FIG. 2). The second base swaging punch 13 constitutes a second swaging punch for further deforming the already-deformed portion of the non-through-holed member A, which has been plastically deformed by the first swaging punch (the first base swaging punch 12 and the die 20), within the through-hole H, and the die swaging punch 23 constitutes a third swaging punch for holding the aforementioned already-deformed portion of the non-through-holed member A between the die swaging punch 23 and the second swaging punch (the second base swaging punch 13) and deforming this already-deformed portion of the non-through-holed member A so that this portion comes into intimate contact with the wall surface W of the through-hole H.

According to the above described embodiment of the joining device, the non-through-holed member A and the through-holed member B are joined together with high peel strength because a part of the non-through-holed member A is plastically deformed to come in intimate contact with the wall surface W of the through-hole H that inclines relative to a direction orthogonal to a plane in which the through-holed member B lies. In other words, a part of the non-through-holed member A is forced radially outwards from the minimum diameter D1 of the through-hole H of the truncated conical projection P to bank up against (lie on) the wall surface W.

In the above illustrated embodiment of the joining device, since the conical tip 23a is formed on the die swaging punch 23, an annular (doughnut-shaped) raised portion P′ with its center on the central axis of the through-hole H is formed on the portion of the non-through-holed member A which projects into the through-hole H. The annular raised portion P′, which is raised toward the die swaging punch 23, is effective at enhancing the peel strength.

In a state where the non-through-holed member A and the through-holed member B are joined together, the through-holed member B has been deformed into the truncated conical projection P at the through-hole H; moreover, the non-through-holed member A includes the annular raised portion P′, which has been deformed along the truncated conical projection P to project from the through-hole H; and furthermore, the annular raised portion P′ is in intimate contact with the wall surface W of the through-hole H, so that a high peel strength can be obtained.

The swaging end of the die swaging punch 23 does not necessarily need to be formed as the conical tip 23a. Namely, although the conical tip 23a is effective at forming the annular raised portion P′ more securely on the non-through-holed member A and enhancing the peel strength, the non-through-holed member A can be deformed to come into intimate contact with the wall surface W of the through-hole H (the truncated conical projection P) even if the swaging end of the die swaging punch 23 is flat.

As can be seen from the above descriptions, the difference between the inner diameter d3 of the die 20 (the annular tapered portion 22) and the inner diameter D of the through-hole H of the through-holed member B determines the diameter of the truncated conical projection P, and the angle α of the annular tapered portion 22 of the die 20 determines the inclination of the truncated conical projection P. These values are determined so that a high binding force is obtained. A sufficient peel strength cannot be easily obtained if the angle α is too small (e.g., smaller than 5 degrees), and the through-holed member B cannot be easily deformed or portions of the non-through-holed member A and the through-holed member B which are swaged together become too thick if the angle α is too large (e.g., greater than 45 degrees).

In the above described embodiment of the joining device, the first base swaging punch 12 and the second base swaging punch 13 are formed as a hollow cylinder and a solid shaft, respectively, which are concentrically arranged to be movable relative to each other in the axial direction, so that the above described first and second deforming steps can be performed sequentially. However, it is possible that the first swaging punch and the second swaging punch be made as separate members and that the first deforming step and the second deforming step be performed at different times. In this case, it is desirable that the first swaging punch be made as a solid shaft. Additionally, the edges of the swaging ends of the first and second swaging punches can be formed as chamfered or tapered edges.

Obvious changes may be made in the specific embodiment of the present invention described herein, such modifications being within the spirit and scope of the invention claimed. It is indicated that all matter contained herein is illustrative and does not limit the scope of the present invention.

What is claimed is:

1. A method for joining a holed member, including a through-hole, and an unholed member together, said method comprising:
deforming said unholed member against said through-hole of said holed member so that a flat portion of said holed member around said through-hole is deformed into a shape of a truncated conical projection and so that said unholed member is deformed along said truncated conical projection to partly project from said through-hole; and
deforming a portion of said unholed member which projects from said through-hole to come into intimate contact with a wall surface of said through-hole of said holed member.

2. The joining method according to claim 1, wherein upon said truncated conical projection being formed, said wall surface inclines relative to a direction orthogonal to a plane in which said holed member lies.

3. The joining method according to claim 1, wherein upon said portion of said unholed member coming into intimate contact with said wall surface, said portion of said unholed member which projects from said through-hole is raised to form an annular raised portion positioned about a central axis of said through-hole.

4. The joining method according to claim 1, further comprising:
holding said unholed member and said holed member between a swaging base and a die before deforming said unholed member against said through-hole.

5. A joining device for joining a holed member, including a through-hole, and an unholed member together, said joining device comprising:
a first swaging punch for deforming said unholed member together with a portion of the holed member around said through-hole;
a second swaging punch for further deforming a portion of said unholed member already deformed by said first swaging punch within said through-hole; and
a third swaging punch for holding said portion of said unholed member between said third swaging punch and said second swaging punch and deforming said portion of said unholed member so that said portion of said unholed member comes into intimate contact with a wall surface of said through-hole of said holed member.

6. The joining device according to claim 4, wherein said first swaging punch comprises a swaging base and a die for holding said unholed member and said holed member therebetween.

7. The joining device according to claim 6, wherein said die is shaped as a hollow cylinder, and wherein said third swaging punch is concentrically positioned inside said hollow cylinder.

8. A joining device for joining a holed member, including a through-hole, and an unholed member together, said joining device comprising:
a swaging base and a die for holding said holed member and said unholed member therebetween;
an annular contacting portion formed on said die and coming in contact with a first flat portion of said holed member around said through-hole;
an annular tapered portion formed on said die and positioned inside said annular contacting portion so as to be concentric therewith;
a first base swaging punch which is greater in diameter than said through-hole and is moved to project toward said annular tapered portion from said swaging base which is in contact with said unholed member to deform said unholed member so that a second flat portion of said holed member around said through-hole is deformed into the shape of a truncated conical projection and so that said unholed member is deformed along said truncated conical projection to partly project from said through-hole, said second flat portion being provided at a radially inner position with respect to said first flat portion;
a second base swaging punch which is smaller in diameter than said first base swaging punch and projects toward a center of said truncated conical projection from said swaging base; and
a die swaging punch for holding a portion of said unholed member which projects from said through-hole between said die swaging punch and said second base swaging punch, and for deforming said portion of said unholed member so as to come into intimate contact with a wall surface of said through-hole of said holed member.

9. The joining device according to claim 8, wherein said first base swaging punch and said second base swaging punch are concentric with each other and are movable relative to each other.

10. The joining device according to claim 8, wherein said die swaging punch comprises a conical projection at an end thereof which faces said second base swaging punch.

11. The joining device according to claim 8, wherein said swaging base and said die are relatively movable toward and away from each other along a central axis of said through-hole.

12. A joining structure in which a holed member, including a through-hole, and an unholed member are joined together,
wherein said holed member is partly swaged into a truncated conical projection at said through-hole, wherein said unholed member is partly swaged along said truncated conical projection to project from said through-hole, and
wherein a portion of said unholed member which projects from said through-hole, around which said truncated conical projection is positioned, is in intimate contact with a wall surface of said through-hole of said holed member.

13. The joining structure according to claim 12, wherein said portion of said unholed member that projects from said through-hole comprises an annular raised portion positioned about a central axis of said through-hole.
